(19) United States
(12) Patent Application Publication
(10) Pub. No.: US 2007/0146451 A1
(43) Pub. Date: Jun. 28, 2007

(54) Inkjet printhead

(75) Inventors: Bang-Weon Lee, Yongin-si (KR); Mio-soo Kim, Seoul (KR); Keon Kuk, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/505,430

(22) Filed: Aug. 17, 2006

(30) Foreign Application Priority Data
Dec. 27, 2005 (KR) 2005-130613

(51) Int. Cl. B41J 2/17

(52) U.S. Cl. 347/94

(57) ABSTRACT

An ink path structure and an inkjet printhead including an ink chamber to be filled with ink to be ejected, a nozzle through which the ink in the ink chamber is ejected, an ink feed hole to supply the ink to the ink chamber, and a restrictor connecting the ink chamber and the ink feed hole, the restrictor including a flow resistance control portion in which an ink path toward the ink feed hole is formed to be longer than an ink path toward the ink chamber such that a flow resistance toward the ink feed hole greater than a flow resistance toward the ink chamber.

### CROSS-REFERENCE TO RELATED APPLICATIONS

This application claims priority under 35 U.S.C. §119(a) from Korean Patent Application No. 10-2005-0130613, filed on Dec. 27, 2005, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to an inkjet printhead having an ink path structure to prevent a back flow of ink and to increase energy efficiency.

2. Description of the Related Art

Generally, an inkjet printer is an apparatus that ejects ink droplets from an inkjet printhead on desired positions of recording paper in order to print predetermined color images. Inkjet printers are classified into a shuttle type inkjet printer having a printhead that is shuttled in a direction perpendicular to a transporting direction of a print medium to print an image, and a line printing type inkjet printer having a page-wide array printhead corresponding to a width of the print medium. The line printing type inkjet printer has been developed for high-speed printing. In the array printhead, a plurality of inkjet printheads are arranged in a predetermined arrangement. In the line printing type inkjet printer, the array printhead is fixed and a print medium is transported, thereby allowing the high-speed printing.

Inkjet printheads are categorized into two types according to the ink droplet ejection mechanisms thereof: a thermal inkjet printhead and a piezoelectric inkjet printhead. The thermal inkjet printhead ejects ink droplets due to an expansion force of ink bubbles generated by thermal energy. The piezoelectric inkjet printhead ejects ink droplets by a pressure applied to ink due to a deformation of a piezoelectric body.

FIG. 1 is a plane view illustrating a conventional thermal inkjet printhead and FIG. 2 is a cross-sectional view illustrating the inkjet printhead of FIG. 1 along a line II-II′. Referring to FIGS. 1 and 2, the conventional printhead includes a substrate 10 in which an ink feed hole 12 for supplying ink is formed, a chamber layer 20 stacked on the substrate 10, and a nozzle layer 30 stacked on the chamber layer 20. A plurality of ink chambers 22 filled with ink to be ejected and a plurality of restrictors 24, which are paths to supply ink to the ink chambers 22, are formed in the chamber layer 20. A common inlet 26 is formed between the restrictors 24 and the ink feed hole 12. As illustrated in FIG. 1, a first opening of the restrictor 24 in communication with the ink chamber 22 is on the same central axis as a second opening of the restrictor 24 in communication with the ink feed hole 12 (though the common inlet 26). That is, the first and second openings of the restrictor 24 are aligned with one another along a straight line. A plurality of nozzles 32 for ejecting ink are formed in the nozzle layer 30. Heaters 25 for heating the ink to generate bubbles are formed on each bottom of corresponding ones of the ink chambers 22.

In the above described conventional configuration, when the ink is filled in the ink chamber 22 and a current is applied to the heaters 25, the ink around the heaters 25 is heated. Thus, the bubbles are generated in the ink, and the ink in the ink chamber 22 is ejected through the nozzle 32 to outside of the conventional printhead due to an expansion force of the bubbles. After the ink is ejected, the ink chamber 22 is refilled with ink via the ink feed hole 12, the common inlet 26, and the restrictor 24.

However, in the above described ink path structure of the conventional inkjet printhead, a back flow of the ink, that is, where the ink in the ink chamber 22 flows toward the ink feed hole 12 in the restrictor 24 during ink ejection as opposed to through the nozzle 32, occurs. Thus, an amount of the ink to be refilled in the ink chamber 22 from the ink feed hole 12 increases not only by an amount of the ink ejected through the nozzle 32 but also by the amount of the backflowed ink, thereby decreasing a driving frequency of the conventional inkjet printhead. Also, energy that the heater 25 receives is used not only for ink ejection but also for the back flow of the ink from the ink chamber 22 toward the ink feed hole 12, and thus an energy efficiency of the conventional inkjet printhead decreases. Since an array printhead has several tens of thousand of heaters, the decrease in energy efficiency is a serious problem for an array printhead.

The back flow of the ink and the energy efficiency drop due to the conventional ink path structure have been described above with respect to the thermal inkjet printheads. However, such problems can also occur in piezoelectric inkjet printheads having a similar ink path structure.

### SUMMARY OF THE INVENTION

The present general inventive concept provides an inkjet printhead having an ink path structure to prevent a back flow of ink, thereby increasing an energy efficiency thereof.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink path structure in an inkjet printhead, including an ink chamber to be filled with ink to be ejected, a nozzle through which the ink in the ink chamber is ejected, an ink feed hole to supply ink to the ink chamber, and a restrictor connecting the ink chamber and the ink feed hole, the restrictor including a flow resistance control portion in which an ink path toward the ink feed hole is formed to be longer than an ink path toward the ink chamber such that a flow resistance toward the ink feed hole greater than a flow resistance toward the ink chamber.

The restrictor may include a first connection hole connecting the ink chamber and the flow resistance control portion and having a first central axis, and a second connection hole connecting the flow resistance control portion and the ink feed hole and having a second central axis different from the first central axis.

The flow resistance control portion may include a curve formed at one side thereof to increase a length of the ink path toward the ink feed hole and to suppress the ink flow toward the ink feed hole.

The restrictor may include an island formed therein to separate the ink path toward the ink feed hole and the ink path toward the ink chamber.

The foregoing and/or other aspects and utilities of the present general inventive concept may also be achieved by providing an inkjet printhead, including a substrate having an ink feed hole to supply ink, a chamber layer stacked on the substrate and having an ink chamber to be filled with ink to be ejected and a restrictor connecting the ink chamber and the ink feed hole, and a nozzle layer stacked on the chamber layer and having a nozzle through which the ink of the ink chamber is ejected, wherein the restrictor includes a flow resistance control portion in which an ink path toward the ink feed hole is formed to be longer than an ink path toward the ink chamber such that a flow resistance toward the ink feed hole greater than a flow resistance toward the ink chamber.

The inkjet printhead may be a thermal inkjet printhead or a piezoelectric inkjet printhead.

The foregoing and/or other aspects and utilities of the present general inventive concept may also be achieved by providing a printhead, including a nozzle unit to eject ink, an ink chamber to contain the ink to be ejected by the nozzle unit, an ink feed hole to supply the ink to the ink chamber, and a restrictor in communication with the ink chamber and the ink feed hole, and defining a first ink path from the ink feed hole to the ink chamber having a first distance and a second ink path from the ink chamber to the ink feed hole having a second distance that is greater than the first distance.

A first portion of the restrictor in communication with the ink chamber may be offset from a second portion of the restrictor in communication with the ink feed hole along a straight line extending from a center of the ink chamber through a center of the first portion of the restrictor. The restrictor may include a rounded portion defining the second ink path. The restrictor may include a straight edge portion defining the first ink path. A flow resistance along the first ink path may be less than a flow resistance along the second ink path.

The restrictor may include a first end part in communication with the ink chamber and having a first width, a second end part in communication with the ink feed hole and having a second width, and a middle part between the first and second end parts and having third width that is greater than the first and second widths. The first and second widths may be equal. The first and second end parts may be offset from each other. The middle part of the restrictor may include a rounded portion to increase a flow resistance along the second ink path such that the ink flows indirectly from the ink chamber through the restrictor to the ink feed hole in a recirculation flow pattern. The middle part of the restrictor may include a straight edge portion such that the ink flows substantially directly from the ink feed hole through the restrictor to the ink chamber. The middle part of the restrictor may include a separation structure to separate the first and second ink paths.

The foregoing and/or other aspects and utilities of the present general inventive concept may also be achieved by providing a printhead, including a nozzle unit having a nozzle, an ink chamber to contain ink to be ejected through the nozzle, an ink feed hole to supply the ink to the ink chamber, and a restrictor disposed between the ink chamber an the ink feed hole, and having a first opening to communicate with the ink chamber and a second opening to communicate with the ink feed hole, the second opening disposed on a line different from a line connecting the nozzle to a center of the first opening.

The restrictor may include a control portion disposed between the first opening and the second opening and having a cross-section varying from the first opening to the second opening. The restrictor may further include sidewalls to define the control portion, and the sidewalls may include a straight surface wall and a curved surface wall. The printhead may further include a chamber layer having bottom and first side walls to define the ink chamber with the nozzle unit and having second side walls to define the restrictor with the nozzle unit. The second side walls may include a first sub-side wall and a second sub-side wall spaced apart from the first sub-side wall by a width varying according to a distance from one of the first opening and the second opening. The restrictor may include a control portion disposed between the first opening and the second opening and having a first side surface and a second side surface, and an island formed in the control portion and having a first side sub-surface corresponding to the first side surface and a second side sub-surface corresponding to the second side surface.

The foregoing and/or other aspects and utilities of the present general inventive concept may also be achieved by providing a printhead, including a nozzle unit having a nozzle, an ink chamber to contain ink to be ejected through the nozzle, an ink feed hole to supply the ink the ink chamber, and a restrictor having a first opening to communicate with the ink chamber, a second opening to communicate with the ink feed hole, and a control portion disposed between the first opening and the second opening and defined by sidewalls having different lengths between the first opening and the second opening.

A first line connecting a center of the in chamber and a center of the first opening may have an angle with a second line connecting the center of the ink chamber and a center of the second opening.

The foregoing and/or other aspects and utilities of the present general inventive concept may also be achieved by providing a method of controlling a flow of ink in an inkjet printhead, including forming a first ink path from an ink feed hole through a restrictor to an ink chamber in communication with a nozzle unit, the first ink path having a first distance and a first flow resistance, and forming a second ink path from the ink chamber through the restrictor to the ink feed hole, the second ink path having a second distance greater than the first distance and a second flow resistance greater than the first flow resistance.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plane view illustrating a conventional inkjet printhead;

FIG. 2 is a cross-sectional view illustrating the inkjet printhead of FIG. 1 along a line II-II′;

FIG. 3 is a plane view illustrating an inkjet printhead according to an embodiment of the present general inventive concept;

FIG. 4 is a cross-sectional view illustrating the inkjet printhead of FIG. 3 along a line IV-IV′;

FIG. 5A is a view illustrating ink flow in a restrictor during ink ejection in the inkjet printhead of FIG. 3 according to an embodiment of the present general inventive concept;

FIG. 5B is a view illustrating ink flow in a restrictor during ink refilling in the inkjet printhead of FIG. 3 according to an embodiment of the present general inventive concept;

FIGS. 6A and 6B are views respectively illustrating a conventional ink path structure and an ink path structure of the inkjet printhead of FIG. 3 according to an embodiment of the present general inventive concept to compare ink back flow and refilling capabilities thereof, and;

FIG. 7 is a view illustrating a modification of an inkjet printhead according to an embodiment of the present general inventive concept.

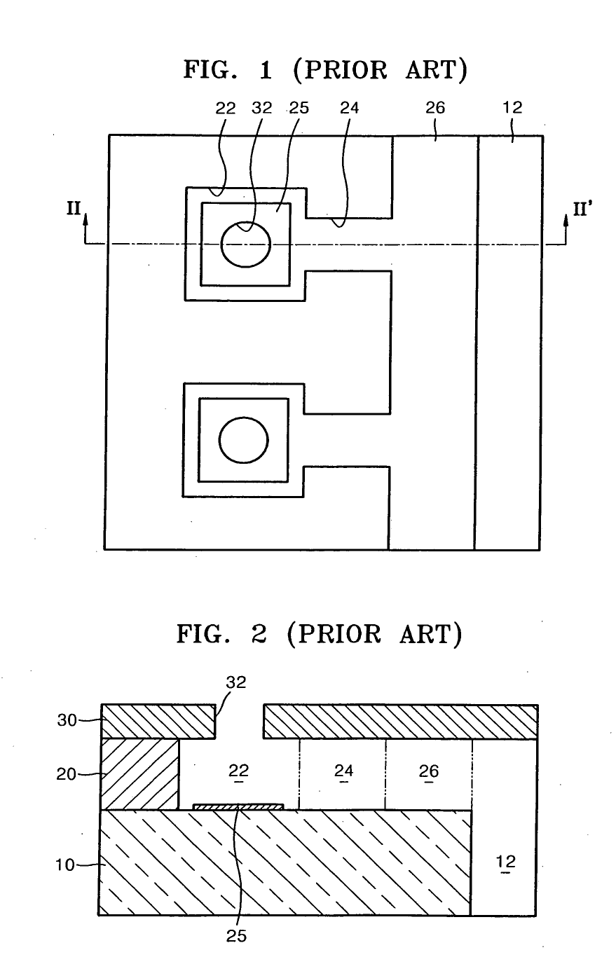

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

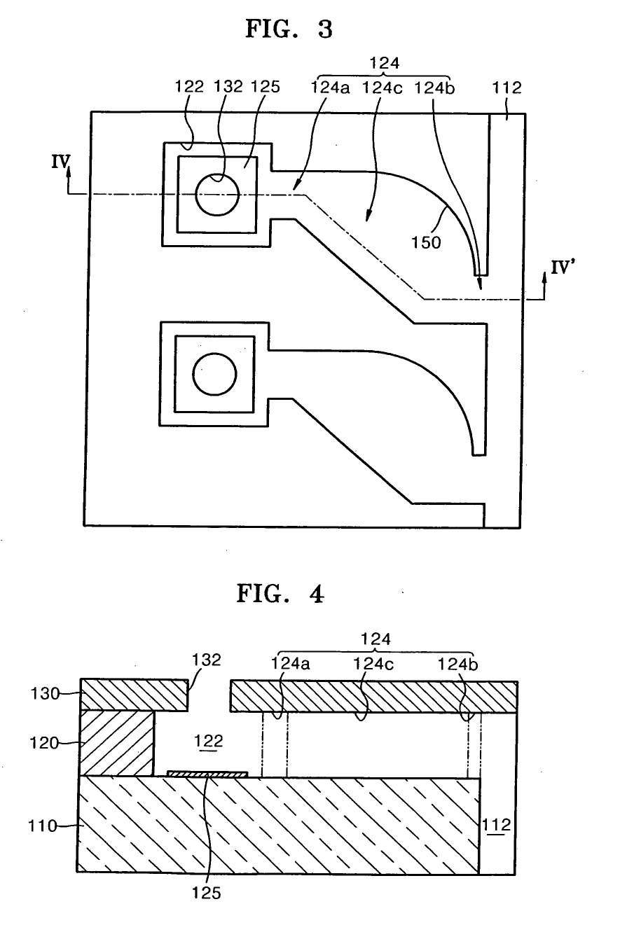

FIG. 3 is a plane view illustrating an inkjet printhead according to an embodiment of the present general inventive concept and FIG. 4 is a cross-sectional view illustrating the inkjet printhead of FIG. 3 along a line IV-IV′. Referring to FIGS. 3 and 4, the inkjet printhead in the present embodiment includes a substrate 110 in which an ink feed hole 112 is formed, a chamber layer 120 is stacked on the substrate 110, and a nozzle layer 130 is stacked on the chamber layer 120. A plurality of ink chambers 122 and restrictors 124 are formed in the chamber layer 120. A plurality of nozzles 132 are formed in the nozzle layer 130. An ink path structure is formed to include the ink feed hole 112, the restrictor 124, the ink chamber 122, and the nozzle 132, as illustrated in FIGS. 3 and 4.

The ink feed hole 112 is formed through the substrate 110 to supply ink to each of the ink chambers 122. The ink chamber 122 is filled with ink to be ejected and a heater 125 is formed on the bottom of the ink chamber 122 to heat the ink therein to generate bubbles in the ink. The restrictor 124 is a path to supply ink to the ink chamber 122 from the ink feed hole 112 and is formed to correspond to the ink chamber 122. The nozzle 132 is formed to communicate with the ink chamber 122 and the ink in the ink chamber 122 is ejected through the nozzle 132.

The restrictor 124 includes a first connection hole 124a connected to the ink chamber 122, a second connection hole 124b connected to the ink feed hole 112, and a flow resistance control portion 124c formed between the first connection hole 124a and the second connection hole 124b. The first and second connection holes 124a and 124b have different central axes. That is, the first and second connection holes 124a and 124b are offset from each other along a straight line extending from a central of the ink chamber 122 through a center of the first connection hole 124a. The flow resistance control portion 124c includes a curve 150 at one side thereof that elongates the ink path toward the ink feed hole 112 and at the same time suppresses the ink flow toward the ink feed hole 112. The flow resistance control portion 124c reduces back flow of the ink during ink ejection and facilitates ink refilling of the ink chamber 122. In detail, since the ink path toward the ink feed hole 112 is longer than the ink path toward the ink chamber 122 due to the curve 150, a flow resistance toward the ink feed hole 112 is greater than a flow resistance toward the ink chamber 122. Accordingly, the flow resistance toward the ink feed hole 112 during ink ejection due to bubble expansion is increased and the back flow of the ink is reduced, and during ink refilling, the flow resistance toward the ink chamber 122 is reduced, and thus the ink is easily refilled into the ink chamber 122.

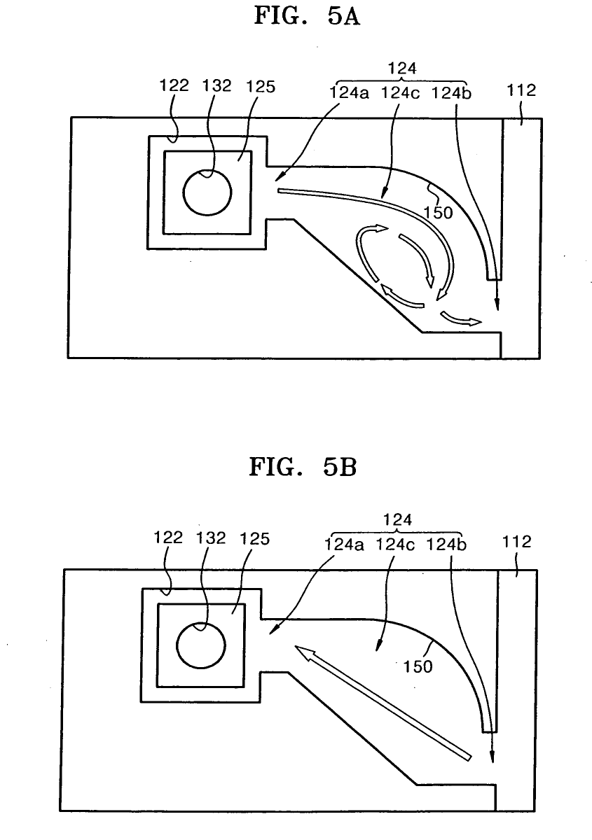

FIG. 5A illustrates the ink flow in the restrictor 124 of FIG. 3 during the ink ejection due to the bubble expansion in the inkjet printhead of the present embodiment. Referring to FIG. 5A, the ink path toward the ink feed hole 112 is elongated by the curve 150 of the flow resistance control portion 124c during the ink ejection due to the bubble expansion and the ink flow toward the ink feed hole 112 is suppressed by the curve 150. Thus, the flow resistance toward the ink feed hole 112 increases and the back flow of the ink is reduced. Also, as illustrated in FIG. 5A, a recirculation area of the ink flow in which the portion of ink backflowing toward the ink feed hole 112 on the curve 150 returns to the ink chamber 122 is formed, and thus the back flow of the ink can be reduced more effectively.

FIG. 5B illustrates the ink flow in the restrictor 124 of FIG. 3 during the ink refilling of the ink chamber 122 due to a bursting of the bubbles in the inkjet printhead of the present embodiment. Referring to FIG. 5B, during the ink refilling of the ink chamber 122, after the ink is ejected and the ink bubbles have burst, the ink does not meet the curve 150, and thus the ink path toward the ink feed hole 112 becomes shorter. Thus, the flow resistance toward the ink chamber 122 is reduced, and thus the ink is easily refilled into the ink chamber 122.

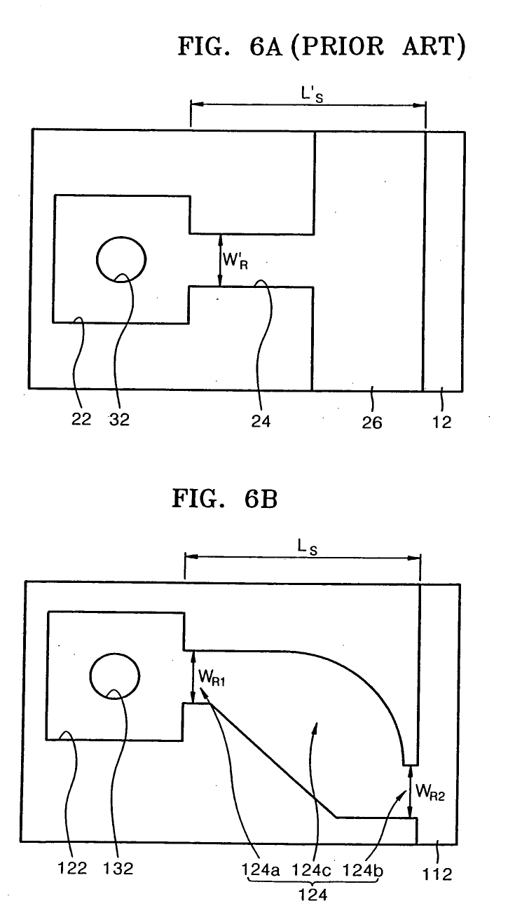

An experimental comparison of a back flow of ink and a refilling capabilities of a conventional ink path structure illustrated in FIG. 6A and an ink path structure of the inkjet printhead of FIG. 3 according to an embodiment of the present general inventive concept illustrated in FIG. 6B is presented below. A total length L′_{S} of the conventional restrictor 24 and the conventional common inlet 26 in the conventional ink path structure is equal to a length L_{S} of the restrictor 124 in the ink path structure of the inkjet printhead of the present embodiment. A width W′_{R} of the conventional restrictor 24 in the conventional ink path structure is equal to a width W_{R1} of the first connection hole 124a and a width W_{R2} of the second connection hole 124b constituting the restrictor 124 in the ink path structure of the inkjet printhead of the present general inventive concept. For example, each of the widths W′_{R}, W_{R1}, and W_{R2} may be 14 μm. According to the experimental results, when the back flow amount of the ink generated during the ink ejection and the refill flow amount of the ink generated during the ink refilling in the conventional ink path structure are 100 and 100, respectively, the back flow amount and the refill amount of the ink in the ink path structure of the present embodiment are 79 and 96, respectively. Accordingly, the back flow amount of the ink is reduced by 21% in the ink path structure of the present embodiment in comparison with the conventional ink path structure, and the refill amount of the ink is almost equal. Meanwhile, the widths W_{R1} and W_{R2} of the first and second connection holes 124a and 124b constituting the restrictor 124 can have various values according to design conditions. When the back flow amount of the ink generated during the ink ejection and the refill flow amount of the ink generated during the ink refilling in the conventional ink path structure are assumed to be 100 and 100 as a reference value, respectively, the back flow amount and the refill amount of the ink in the ink path structure of the present embodiment are 79 and 96, respectively. Accordingly, the back flow amount of ink and the refill amount of ink described in paragraph [0040] have no units of measure.

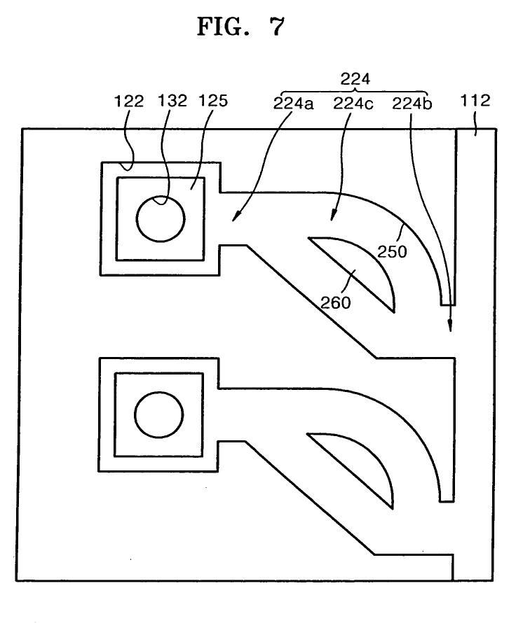

FIG. 7 is a plane view illustrating a modification of an ink jet printhead according to an embodiment of the present general inventive concept. Features different from the previous embodiment described above with reference to FIGS. 3-6B will be described hereinafter. Referring to FIG. 7, an ink path structure includes an ink feed hole 112 to supply ink, an ink chamber 122 filled with ink to be ejected, a nozzle 132 through which ink is ejected, and a restrictor 224 connecting the ink feed hole 112 and the ink chamber 122.

The restrictor 224 includes a first connection hole 224a connected with the ink chamber 122, a second connection hole 224b connected with the ink feed hole 112, and a flow resistance control portion 224c disposed between the first connection hole 224a and the second connection hole 224b. The first connection hole 224a and the second connection hole 224b have different central axes. That is, the first and second connection holes 224a and 224b are offset from each other along a straight line extending from a central of the ink chamber 122 through a center of the first connection hole 124a. A curve 250 is formed at one side of the flow resistance control portion 224c to elongate the ink path toward the ink feed hole 112 and to suppress the ink flow toward the ink feed hole 112. The flow resistance control portion 224c reduces the back flow of the ink by increasing a flow resistance toward the ink feed hole 112 during ink ejection and facilitates the ink refilling of the ink chamber 122 by reducing a flow resistance toward the ink chamber 122 during the ink refilling of the ink chamber 122 after ink bubbles have burst.

An island 260 may be formed in the flow resistance control portion 124c to separate the ink path toward the ink feed hole 112 during ink ejection and the ink path toward the ink chamber 122 during the ink refilling of the ink chamber 122. In the ink path structure of the present embodiment, the ink path toward the ink feed hole 112 during the ink ejection is longer than the ink path toward the ink chamber 122 during the ink refilling of the ink chamber 122 due to the curve 250 formed at the one side of the flow resistance control portion 224c, and thus the flow resistance toward the ink feed hole 112 becomes greater than the flow resistance toward the ink chamber 122.

Although the embodiments illustrated in FIGS. 3-7 are described above with reference to a thermal inkjet printhead, ink path structures according to various embodiments of the present general inventive concept can also be applied to other types of printheads, such as a piezoelectric inkjet printhead.

As described above, the ink path structure of an inkjet printhead according to embodiments the present general inventive concept has the several beneficial effects. For example, back flow of ink flowing to an ink feed hole during ink ejection from an ink chamber can be prevented, and after the ink is ejected, a speed of a refilling of ink into the ink chamber can be increased. Accordingly, a driving frequency of the inkjet printhead can be increased.

Furthermore, since a back flow of ink in a thermal inkjet printhead can be prevented, most energy input to a heater thereof can be used to eject the ink. Thus, an energy efficiency of the heater can be increased. Also, since most energy input to an actuator in a piezoelectric inkjet printhead can be used to eject the ink, an efficiency of the actuator can be increased. Thus, as energy efficiency is increased, an amount of energy input into the inkjet printhead can be reduced.

In addition, as the energy input to the heater in the thermal inkjet printhead is reduced, heat generated by the heater is prevented from accumulating inside of the thermal inkjet printhead. Moreover, as a low power driving is required to drive an array printhead including a number of heaters, a low power driving is possible when the ink path structure of various embodiments of the present general inventive concept is used in array printheads.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink path structure in an inkjet printhead, comprising:
an ink chamber to be filled with ink to be ejected;
a nozzle through which the ink in the ink chamber is ejected;
an ink feed hole to supply ink to the ink chamber; and
a restrictor connecting the ink chamber and the ink feed hole, the restrictor comprising a flow resistance control portion in which an ink path toward the ink feed hole is formed to be longer than an ink path toward the ink chamber such that a flow resistance toward the ink feed hole greater than a flow resistance toward the ink chamber.

2. The ink path structure of claim 1, wherein the restrictor comprises:
a first connection hole connecting the ink chamber and the flow resistance control portion and having a first central axis; and
a second connection hole connecting the flow resistance control portion and the ink feed hole and having a second central axis different from the first central axis.

3. The ink path structure of claim 2, wherein the flow resistance control portion comprises:
a curve formed at one side thereof to increase a length of the ink path toward the ink feed hole and to suppress the ink flow toward the ink feed hole.

4. The ink path structure of claim 1, wherein the restrictor comprises:
an island formed therein to separate the ink path toward the ink feed hole and the ink path toward the ink chamber.

5. An inkjet printhead, comprising:
a substrate having an ink feed hole to supply ink;
a chamber layer stacked on the substrate and having an ink chamber to be filled with ink to be ejected and a restrictor connecting the ink chamber and the ink feed hole ; and
a nozzle layer stacked on the chamber layer and having a nozzle through which the ink of the ink chamber is ejected,
wherein the restrictor comprises a flow resistance control portion in which an ink path toward the ink feed hole is formed to be longer than an ink path toward the ink chamber such that a flow resistance toward the ink feed hole greater than a flow resistance toward the ink chamber.

6. The inkjet printhead of claim 5, wherein the restrictor comprises:
a first connection hole connecting the ink chamber and the flow resistance control portion and having a first central axis; and
a second connection hole connecting the flow resistance control portion and the ink feed hole and having a second central axis different from the first central axis.

7. The inkjet printhead of claim 6, wherein the flow resistance control portion comprises:
a curve formed at one side thereof to increase a length of the ink path toward the ink feed hole and to suppress the ink flow toward the ink feed hole.

8. The inkjet printhead of claim 5, wherein the restrictor comprises:
an island formed therein to separate the ink path toward the ink feed hole and the ink path toward the ink chamber.

9. The inkjet printhead of claim 5, wherein the inkjet printhead is a thermal inkjet printhead.

10. The inkjet printhead of claim 5, wherein the inkjet printhead is a piezoelectric inkjet printhead.

11. A printhead, comprising:
a nozzle unit to eject ink;
an ink chamber to contain the ink to be ejected by the nozzle unit;
an ink feed hole to supply the ink to the ink chamber; and
a restrictor in communication with the ink chamber and the ink feed hole, and defining a first ink path from the ink feed hole to the ink chamber having a first distance and a second ink path from the ink chamber to the ink feed hole having a second distance that is greater than the first distance.

12. The printhead of claim 11, wherein a first portion of the restrictor in communication with the ink chamber is offset from a second portion of the restrictor in communication with the ink feed hole along a straight line extending from a center of the ink chamber through a center of the first portion of the restrictor.

13. The printhead of claim. 11, wherein the restrictor comprises:
a rounded portion defining the second ink path.

14. The printhead of claim 11, wherein the restrictor comprises:
a straight edge portion defining the first ink path.

15. The printhead of claim 11, wherein a flow resistance along the first ink path is less than a flow resistance along the second ink path.

16. The printhead of claim 11, wherein the restrictor comprises:
a first end part in communication with the ink chamber and having a first width;
a second end part in communication with the ink feed hole and having a second width; and
a middle part between the first and second end parts and having third width that is greater than the first and second widths.

17. The printhead of claim 16, wherein the first and second widths are equal.

18. The printhead of claim 16, wherein the first and second end parts are offset from each other.

19. The printhead of claim 16, wherein the middle part of the restrictor comprises:
a rounded portion to increase a flow resistance along the second ink path such that the ink flows indirectly from the ink chamber through the restrictor to the ink feed hole in a recirculation flow pattern.

20. The printhead of claim 16, wherein the middle part of the restrictor comprises:
a straight edge portion such that the ink flows substantially directly from the ink feed hole through the restrictor to the ink chamber.

21. The printhead of claim 16, wherein the middle part of the restrictor comprises:
a separation structure to separate the first and second ink paths.

22. A printhead, comprising:
a nozzle unit having a nozzle;
an ink chamber to contain ink to be ejected through the nozzle;
an ink feed hole to supply the ink to the ink chamber; and
a restrictor disposed between the ink chamber an the ink feed hole, and having a first opening to communicate with the ink chamber and a second opening to communicate with the ink feed hole, the second opening disposed on a line different from a line connecting the nozzle to a center of the first opening.

23. The printhead of claim 22, wherein the restrictor comprises:
a control portion disposed between the first opening and the second opening and having a cross-section varying from the first opening to the second opening.

24. The printhead of claim 23, wherein the restrictor further comprises:
sidewalls to define the control portion,
wherein the sidewalls comprise a straight surface wall and a curved surface wall.

25. The printhead of claim 22, further comprising:
a chamber layer having bottom and first side walls to define the ink chamber with the nozzle unit and having second side walls to define the restrictor with the nozzle unit.

26. The printhead of claim 25, wherein the second side walls comprise:
a first sub-side wall and a second sub-side wall spaced apart from the first sub-side wall by a width varying according to a distance from one of the first opening and the second opening.

27. The printhead of claim 25, wherein the restrictor comprises:
a control portion disposed between the first opening and the second opening and having a first side surface and a second side surface; and
an island formed in the control portion and having a first side sub-surface corresponding to the first side surface and a second side sub-surface corresponding to the second side surface.

28. A printhead, comprising:
a nozzle unit having a nozzle;
an ink chamber to contain ink to be ejected through the nozzle;
an ink feed hole to supply the ink the ink chamber; and
a restrictor having a first opening to communicate with the ink chamber, a second opening to communicate with the ink feed hole, and a control portion disposed between the first opening and the second opening and defined by sidewalls having different lengths between the first opening and the second opening.

29. The printhead of claim 28, wherein a first line connecting a center of the in chamber and a center of the first opening has an angle with a second line connecting the center of the ink chamber and a center of the second opening.

30. A method of controlling a flow of ink in an inkjet printhead, the method comprising:
forming a first ink path from an ink feed hole through a restrictor to an ink chamber in communication with a nozzle unit, the first ink path having a first distance and a first flow resistance; and
forming a second ink path from the ink chamber through the restrictor to the ink feed hole, the second ink path having a second distance greater than the first distance and a second flow resistance greater than the first flow resistance.
